(19) United States
(12) Patent Application Publication
(10) Pub. No.: US 2014/0222656 A1
(43) Pub. Date: Aug. 7, 2014

(54) Customized credit reporting system

(71) Applicant: Smyyth Technology LLC, South Plainfield, NJ (US)

(72) Inventors: Shyarsh Desai, Chappaqua, NY (US); Larissa Trofimova, Long Valley, NJ (US); John Metzger, New Hope, PA (US); Paul Smithies, Somerville, NJ (US); Barbara Gerrity, Fanwood, NJ (US); David Palmieri, Chathaml, NJ (US)

(73) Assignee: Smyyth Technology LLC, South Plainfeld, NJ (US)

(21) Appl. No.: 14/153,776

(22) Filed: Jan. 13, 2014

Related U.S. Application Data
(60) Provisional application No. 61/848,867, filed on Jan. 14, 2013.
(60) Provisional application No. 61/848,868, filed on Jan. 14, 2013.

(51) Int. Cl. G06Q 40/02

(52) U.S. Cl. CPC G06Q 40/025
USPC 705/38

(57) ABSTRACT

A novel system and method for facilitating the sharing of data between business entities is disclosed. The novel system and method comprises members sharing or submitting certain of their data to a program which identifies overlaps between entities, and presents each member with a list of these other identified members from which the member may choose to receive data. The novel system and method allows each member to receive highly personalized and relevant credit reports, or other reports, concerning their customers, to facilitate intelligent decisions regarding interactions with their accounts.

### CLAIM OF PRIORITY

Applicant claims priority to U.S. Provisional Patent Application 61/848867, titled “A system for business creditors to identify debtor overlaps between participants by analyzing their accounts receivable portfolios, and to select others with which to exchange credit data, in order to maximize portfolio coverage through overlaps and have access to relevant information. The system monitors, maps and connects participants into a network through their common customers for real-time coverage of relevant [sic] business credit information, and to produce real-time credit reports and analysis,” and to U.S. Provisional Patent Application 61/848868, titled “A real-time business credit report, including or not including credit bureau data, that is unique to the company that is ordering it because it includes customized credit and trade payment reference information from both selected industry groups and business creditors with common customers that have been chosen by the client for their relevance,” both of which were filed on Jan. 14, 2013.

### FIELD OF THE INVENTION

The subject matter of this application relates to methods of gathering, transforming, and distributing information reflective of the health of a business or businesses and of identifying most highly relevant sources of peer data. Data may be gathered from publicly available sources, private analysts, and from user-selected peers within a data-sharing network. A participant (“Member”) in the method may choose peers from which to collect data based on any reason, including that such a peer is identified for the user by the subject matter of this application as being a relevant source of data.

### BACKGROUND

There are many sources available to businesses to assess the health of other businesses. Dun and Bradstreet, Morningstar, Equifax and Experian are four of the larger collectors and brokers of relevant data, although several more targeted information providers and many small industry specific groups exist. Further, other sources of information and data, such as participation in credit networking groups, press releases, S.E.C. information, analyst ratings and commentary, and even personal communication between businesses may all be used to evaluate a business' health.

Perhaps most commonly, such assessments are used to determine the risk one (a “Creditor” or “Seller”) undertakes by extending a line of credit to another (a “Debtor” or “Purchaser”), and such details are an important part of the due diligence a business should undertake before forming almost any type of relationship with another, whether they are a potential debtor, creditor, or other business relationship.

Although it may be relatively easy for a business to obtain reports from large data brokers, and to a lesser extent from smaller industry-specific groups, it is much more challenging for a business to develop relationships beyond a small peer-group and to access peer information in a specific market segment or in another relevant demographic and with limited time-lag in the flow of that information.

Further, the data received from large data brokers may obscure the most valuable information by combining it with less relevant information. For example, a Purchaser purchases certain core products that are fundamental to its business, often from several industry segments, and will also purchase auxiliary, but necessary, general supplies and services such as utilities, office supplies, and transportation. By combining data from a business' core and auxiliary purchases, an overall picture of Purchaser's payment experience as reported by large scale aggregators may show that it is generally meeting its obligations on time, while obscuring the degrading health of payments for its core purchases in one or more industry segments. Such detail may go undiscovered by analysts until a Creditor has been exposed to greater risk than intended by extending credit to Purchaser based on reports from large data aggregators. Further, data obtained from common data aggregators may be several months old, so although a specific Purchaser may have been low-risk when information was gathered months earlier, that may not be the case when a report is generated and distributed to requesting parties.

Faulty, incomplete, and old data may be relied on by a Creditor to determine their allowable exposure to each of several Debtors. Especially in volatile market segments, such reliance can result in a Creditor grossly overestimating the health of a Debtor, and possibly having a payment delay or default endanger a Creditor's business. Increasing the reliability and timeliness of such data would allow Creditors to make better decisions regarding their exposure, reduce overall risk, and even allow Creditors to take on potentially highly profitable additional risk without endangering their own business.

### SUMMARY

The subject matter of this application pertains to a computerized method for collecting, transforming, and disseminating information about a Debtor. The method comprises electronically compiling information about a Debtor such as that disclosed in public filings, tax and lien records, news reports, reports on officers and parent and subsidiary entities, reports by expert analysts in relevant markets, the available data and ratings from third parties such as credit bureaus and industry-specific reporting groups, as well as data from industry peers within a data-sharing network, transforming certain of the data, and making the data available to individual users (“User”).

In particular, the subject matter of this application pertains to a method of analyzing and sharing data about Debtors compiled from Creditor peers, through use of the software that identifies relevant peers (“Peers”) for each User from a group of participating creditors (“Participants”) and then allows peers to form trusted, safe and secure connections with each other (“Trusted Connections”).

Formation of these Trusted Connections between peers authorizes and enables the collecting of trade and payment data from each Peer. Each Participant shares data about their Debtors, manually, or ideally, automatically. Peers are identified based on criteria selected by the method and software such as their, inter alia, common Debtors, market niche, market penetration, and annual revenues. Further, this application permits a User to choose the Peers with whom to form Trusted Connections and such Trusted Connections helps a user create a unique report based on such Trusted Connections. In doing so, the subject matter of this application allows a Member to selectively obtain information from sources which are highly relevant to the Member's own business, industry or industries, rather than more traditional methods which do not enable Members to customize the data scoring or ratings in reports by including or excluding certain contributors of data, or that may consist of data from only a single industry.

Such data as delivered through this application in real-time or near-real-time between Creditors on current core industry-specific credit experience is highly valued by Creditors for determining credit decisions.

### BRIEF DESCRIPTION OF THE DRAWINGS

FIG. 1 is a Venn diagram illustrating how Members comprise the sub-groups of Program Identified Peers and Trusted Peers.

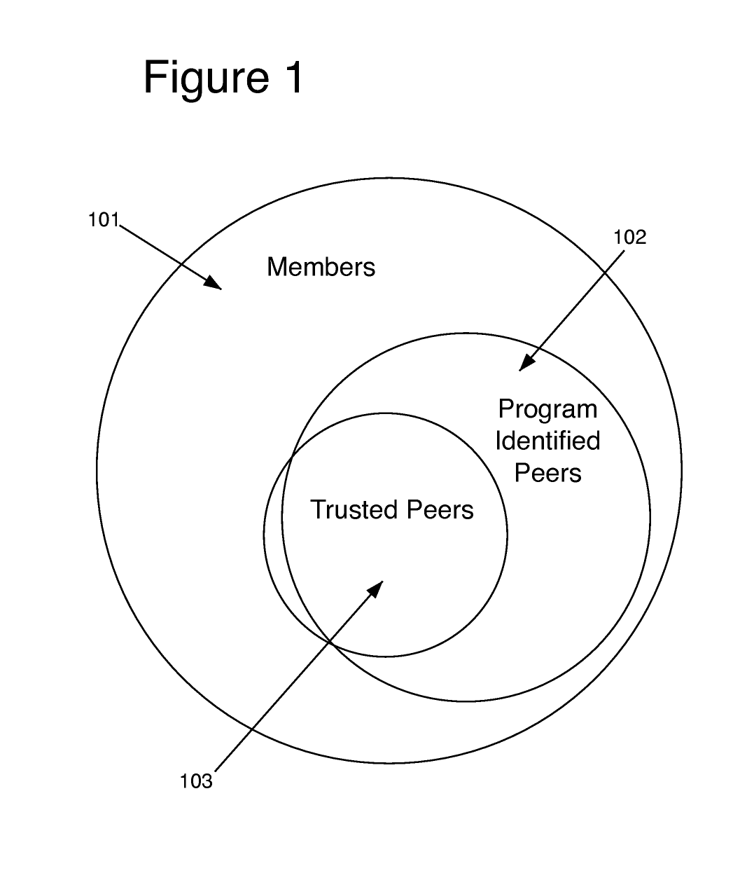

FIG. 2 in a chart illustrating an example of how multiple program Members contribute data on their customers to the Program and the selection of Program Identified Peers by the Program, optimally though an automated, computerized process.

FIG. 3 illustrates an example of how groups of program participants may be designated by the Program as Members of a Program Identified Network.

FIG. 4 illustrates an example of how a Member selects their trusted peers from their Program Identified Peers, to comprise their personal network. This personal network may also comprise one or more Program Identified Network.

FIG. 5 is an exemplary illustration of a graphical user interface showing how a Member may authorize certain data streams to share with the Program.

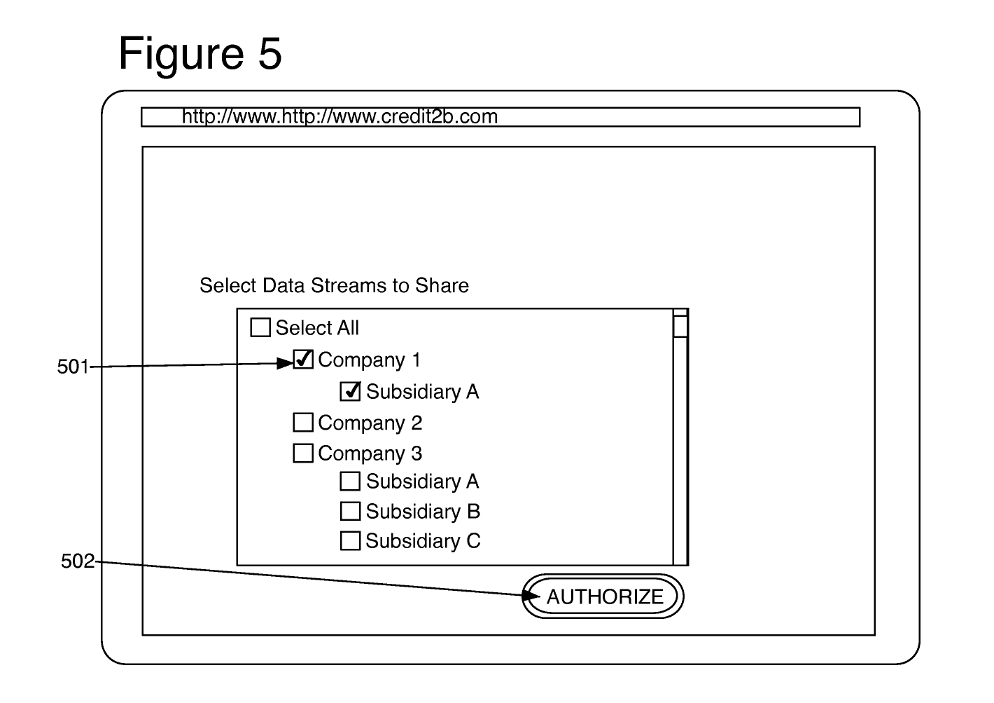

FIG. 6 is an exemplary illustration of a graphical user interface showing how a Member may select Trusted Peers from the Program Identified Peers, and how a Member may selected Program Identified Networks of interest.

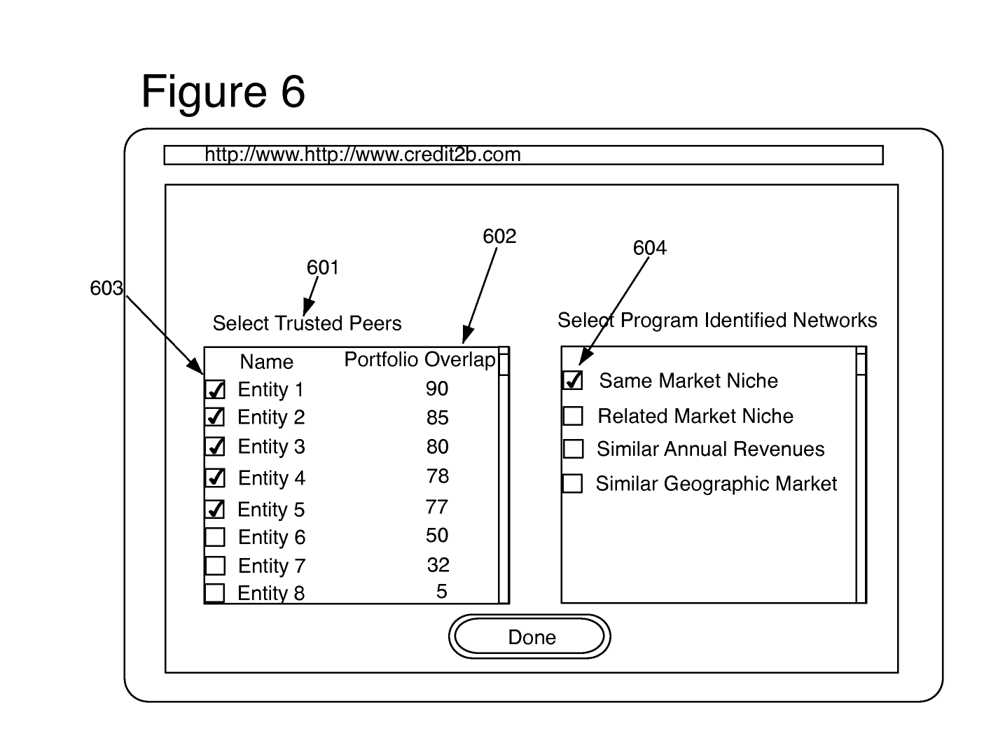

FIG. 7 is an example of one way a Member may receive information of interest through a graphical user interface.

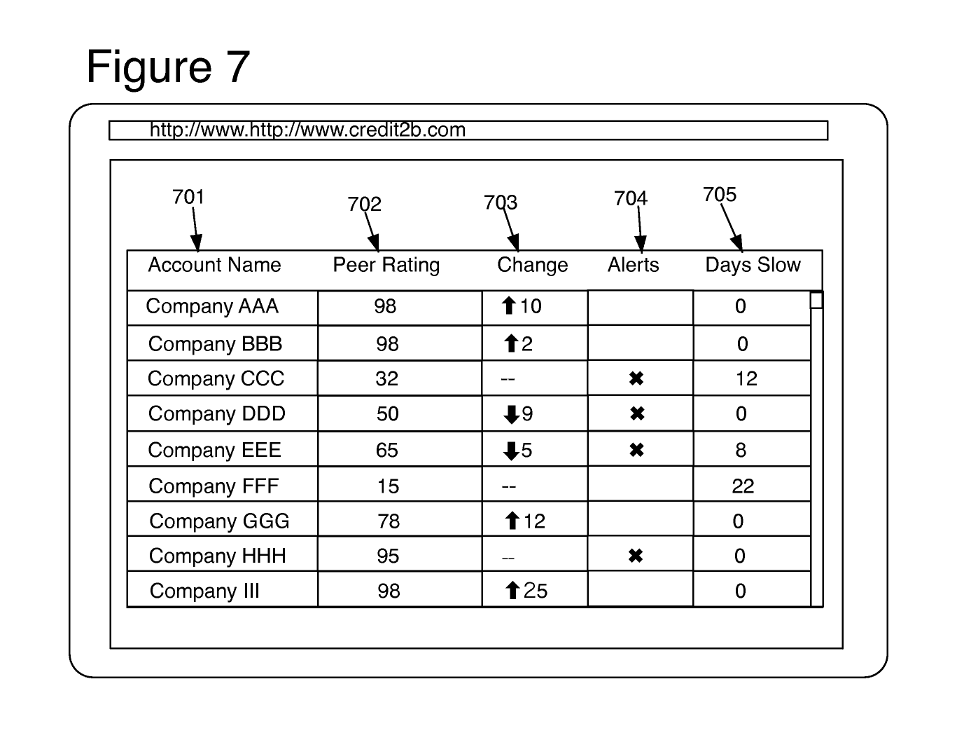

FIG. 8 is an illustration of how Account nomenclature differences between Members are accounted for, and maintained, by the Program.

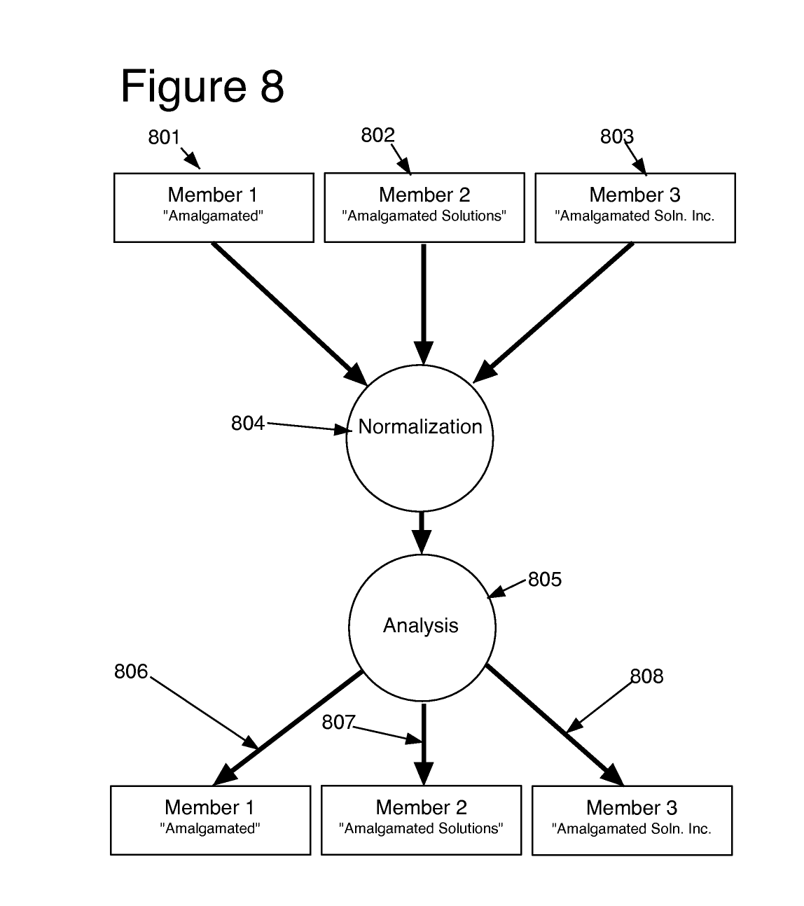

### DETAILED DESCRIPTION OF THE PREFERRED EMBODIMENTS

Although applicant believes a complete understanding of the subject matter of this application may be obtained without reference to illustrations, to ease such understanding, applicant provides several drawings. The following description and drawings referenced therein illustrate embodiments of the application's subject matter. They are not intended to limit the scope. Those familiar with the art will recognize that other embodiments of the disclosed method are possible. All such alternative embodiments should be considered within the scope of the application's claims.

Each reference number consists of three digits. The first digit corresponds to the figure number in which that reference number is first shown. Reference numbers are not necessarily discussed in the order of their appearance in the figures.

For the sake of clarity, a very simple population of Members is illustrated. In practice, the subject matter of this application will be used with a much larger number of Members, each sharing much more complex data than that chosen to exemplify the disclosed inventive concepts.

This application discloses a novel system and method whereby the Program (defined as a computerized algorithm, or a human, or human interacting with a computerized algorithm) obtains or receives data from Members in the program network (101), identifies networks of program-identified peers (“Program Identified Peers”) (102) that have certain commonalities within the program network, allows each Member (201) to identify trusted peers from those within their program-identified peer network (“Trusted Peers”) (103), and allows each Member to obtain relevant data from their Trusted Peers. In a most preferred embodiment, the primary criteria used to identify peers are common customers and Creditors (an “Account” or “Accounts”), although the system and method may utilize other criteria to supplement or supplant the identification process.

Further, the novel system and method allows the Program to create networks of Members in which the membership criteria may be any factor or combination of factors selected by the Program or by its Members.

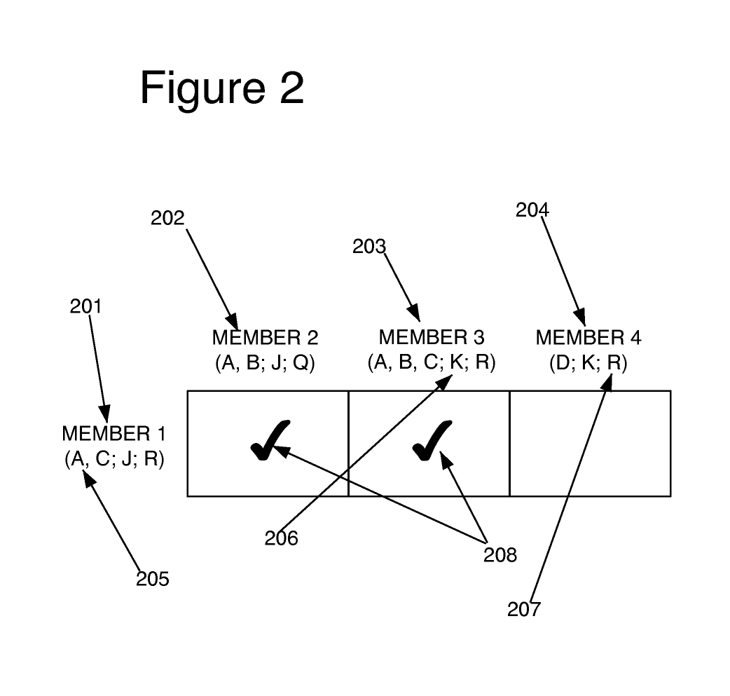

Members contribute data about their business and themselves to the Program, which in turn identifies which Members share certain characteristics. In a preferred embodiment, the primary characteristic used for finding Program Identified Peers are the identities of each Member's Accounts. In that preferred embodiment, the only data that necessarily needs to be shared is that concerning the Member's Accounts. FIG. 2 is an example of this process in a chart form. The column headers represent individual Members (202, 203, and 204), and the row is another Member (201). In this illustration, the Member in the row is matched with other Members (those represented in the columns) according to overlap with the factors illustrated for each Member by the parenthetical letters associated with each Member. For example, letters A, B, and C may each represent a particular Account (205), while letters J, K, and L may each represent a Member's market niche(for example: metal, chemicals, and office supplies) (206), and letters P, Q, and R may represent the Member's geographical market (for example, United States, the Americas, and Worldwide) (207). In this exemplary chart, those Members having Accounts in common (the Program Identified Peers) (102) are indicated with a checkmark.

In this example, Member 1 would be presented with a list of Program Identified Peers and then Member 1 could choose to obtain a personalized credit report derived from all of their Program Identified Peers for each of Member 1's Accounts, or may select a subset of the Program Identified Peers from which to receive such information. Those Program Identified Peers the Member chooses to use to create their personalized credit reports are termed Trusted Peers. In the most preferred embodiment of the subject matter of this application the data received by a Member would comprise credit rating and credit line recommendation information for their Accounts derived from their Trusted Peers' unique experiences with those Accounts.

Optimally, the Program ranks each Member's Program Identified Peers to assist the Member in selecting their Trusted Peers. In one preferred embodiment, a Member is presented with the percent homology (calculated by dividing the number of Accounts shared by a Member and one of that Member's Program Identified Peers, by the total number of the Member's Accounts) between their Accounts and a Program Identified Peer's Accounts. Thereby, Members may choose to only select those Program Identified Peers with a large overlap of Accounts to be Trusted Peers. In other embodiments, a Member's Program Identified Peers may also be ranked on the similarity of other factors such as, inter alia, annual revenues, markets served, geographic market, market share, or other relevant measures.

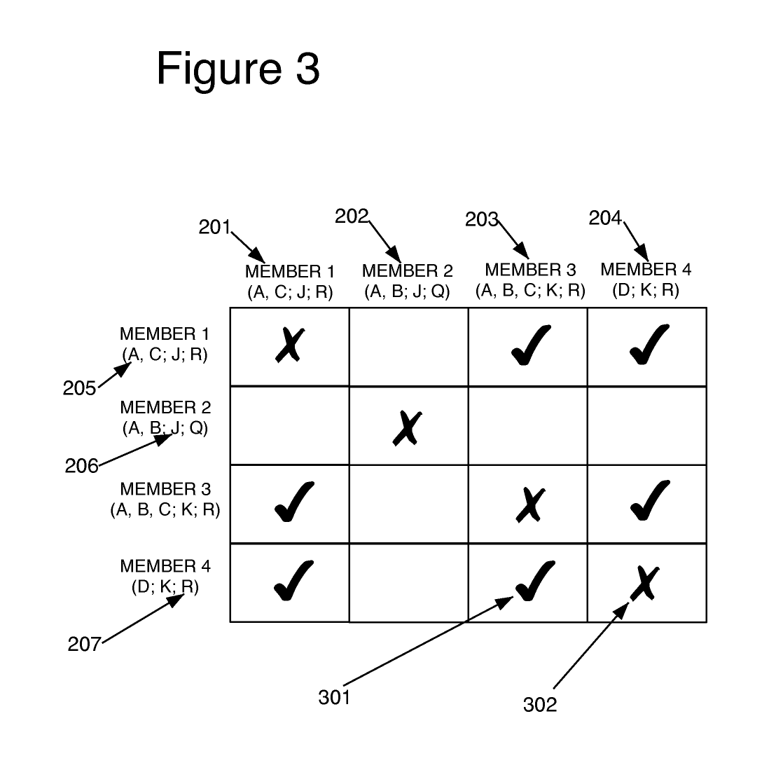

To further assist a Member in selecting their Trusted Peers from the Program Identified Peers, or for other reasons, the Program may also identify networks of Members based on factors other than their Accounts (“Program Identified Networks”). FIG. 3 illustrates a exemplary chart by which all Members are cross-referenced to all other Members (201, 202, 203, and 204) and networks can be identified. In this illustration, Member 1 (201), Member 2 (202), and Member 3 (203) are marked for inclusion in a network (301) based on an overlapping market niche. An “X” indicates where the same Member intersects in this chart (302). Other networks may be identified by the Program based on any other criteria the Program, or a Member, identifies. For example, if a Member requests to obtain data from other Members that have similar annual revenues, the Program can accommodate that request. Such additional data may be used by a Member to, for example, select Program Identified Peers that share an additional characteristic with the Member, such as markets served or annual revenues, to create a Member's set of Trusted Peers. These Program Identified Networks may also be useful to an individual Member in deciding whether to, inter alia, risk exposure in a new market or geographical region.

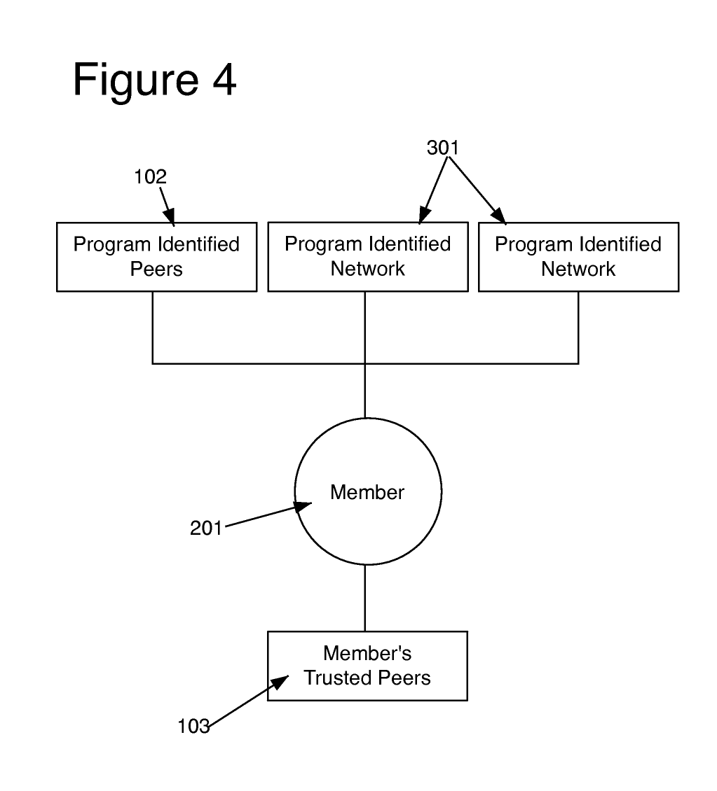

As illustrated in FIG. 4 a Member (201) may be presented with multiple data streams identified and transformed by the Program from the data received by the Program from the Members. Such data streams are typically those from Program Identified Peers (102). A Member may then select the Program Identified Peers from which they wish to receive as Trusted Peers (103). A Member (201) may also elect to receive data from Program Identified Networks (301) of interest either to aid their selection of Trusted Peers, or to supplement their knowledge. In the most preferred embodiments, the data received by a Member from their Trusted Peers is comprised of the Trusted Peers' credit interactions with those Accounts that are also Accounts of the Member, such that a Member receives credit intelligence about their Accounts from their Trusted Peers.

To reiterate, although the subject matter of this application may be used to share almost any type of data, in the most preferred embodiment Members are businesses that share data with the Program concerning their Accounts Receivable (including, inter alia, the names and accounts receivable records of their Debtors, the amount of credit extended to each Debtor, and other business metrics such as the days sales outstanding), and optionally, data about the Member's markets, size, location, as well as any other data deemed important by the Members and the Program. The Program selects those Members that share at least one Account and presents each Member with a list of these other Members (that Member's “Program Identified Peers”), preferably ranked according to the percent homology between Members. Each Member selects from their Program Identified Peers one or more other Members as it's Trusted Peers. The Program receives data from each Member's Accounts, and creates for each Member a personalized credit report for each of the Member's Accounts from the data submitted by the Member's Trusted Peers. Preferably, the data received by the Program (“Raw Data”) is transformed into a score or rating, or a credit line recommendation (collectively “Score”) using methods and algorithms generally known or familiar to those in the art. Typically, multiple Members share data about each Account, and each Member is presented with Scores calculated from the data shared by only their Trusted Peers, In this manner, each Member receives highly relevant and personalized Account Scores for their Accounts. In some embodiments, a Member may receive or view Raw Data from that Member's Trusted Peers to supplement or supplant Scores. In a most preferred embodiment, an Account's Score is calculated as new data is received from Members. In this way, an Account's Score reflects the real-time or near real-time credit experiences of the Members. Other useful embodiments may recalculate an Account's Score periodically or in response to a triggering event. An example of such a Triggering Event is a change in the amount of credit extended or payment experience since the last calculation being above a certain parameter. Another example may be the identification of a deviation from an expected data range by the sharing Member or by the Program. Yet another example of a triggering event would be the manual updating of a record by the Member receiving the Account Score. In addition, although a Member may obtain all the information needed to guide their business decisions from an Account's Score, the Program could allow Members to access raw, aggregate, or partially transformed data received by the Program from that Member's Trusted Peers. To assist the identification of Trusted Peers by each Member, additional data may be presented to a Member concerning the overlap of their business with other Members based on at least one criteria. Such criteria including, without limitation, a Member's served market niches, annual revenues, and geographical markets.

Several embodiments of the subject matter of this application further comprise a communication portal whereby a Member may electronically contact one for more of the Member's Trusted Peers to request further information about an Account. This portal allows electronic communication between Members without the need to share private email addresses. The Program may monitor and archive messages, with the Member's knowledge, to reduce the possibility of a Member or Members exchanging improper information.

After joining the Program, Members grant access to certain of their data to the Program. Most typically these data concern the Member's Accounts. Member's may grant access to the data to be shared via third-party software interfaces (such as may be available for software such as Quicken, SAP, Oracle or other bookkeeping software) or may otherwise electronically link their data with the Program. Members may also submit their data manually to the Program, although automated data transmission is preferred. One exemplary illustration in which this transmission is actuated is a graphical user interface (GUI) presented on the Member's computer, whereby the Member could select data to be shared with the Program by checking an appropriate box (501) and authorize such transmission by clicking an “authorize” button (502) on the screen. In most preferred embodiments, all relevant data is shared by each Member.

The Program analyses the data coming from a Member and identifies other Members that have certain characteristics in common. Most typically, this characteristic is the existence at least one overlapping Account. These Program Identified Peers are suggested to Members (601) via the GUI and may indicate the extent of overlap (602) between Member's portfolio overlap to indicate the fidelity of this potential connection. Each Member chooses (603) from their list of Program Identified Peers to create a personal network of Trusted Peers. A Member may also receive information from Program Identified Networks (604) which may be used to assist the Member's selection of Trusted Peers.

After the Member has selected one or more Trusted Peers, the information shared by those Program Identified Peers are used to create customized credit reports for each of the Member's Accounts (701). This incoming information may be condensed and transformed in a number of ways, depending on the requirements of the Member and the Program. For example, the data coming from Trusted Peers disclosing the number of days a certain Account is taking to pay its invoices (705) and the total amount extended to the account may be compiled and combined with other submitted data to produce a summary score or grade (“Peer Rating”) (702) using techniques and algorithms known in the art. Changes in this Peer Rating (703) is another example of the types of data that could be presented to a Member through the GUI. Other data, such as comments about an Account from Trusted Peers about changes to credit terms, or if an Account experienced a major event (e.g., change in ownership or management) (704) may also be submitted to the Program and distributed to the appropriate Members. In preferred embodiments, a Members' GUI may update as new data is received from the Member's Trusted Peers, or the Program may cause the GUI to update in response to a Triggering Event. Less preferred, but still useful, embodiments have a Member's GUI update in response to an refresh command initiated by a Member or update periodically. Since, in its most preferred embodiment, Member data is submitted automatically, each Member is capable of seeing its personalized credit rating for a Debtor change in real-time, or near real-time. Members may select to view data on their accounts that have been submitted by it's Trusted Peers across time, or by nearly any other manner as required by the Program and the Members. This exemplary set of information is just one of nigh-infinite possible arrangements and presentations of the data that could be constructed as needed by the Program or Members, and should not be interpreted to limit the claims.

In addition, Members may receive in their GUI other relevant information compiled by the Program from other sources. Such other sources including, without limitation, Dun and Bradstreet, Experian, Morningstar and other large collectors and brokers of such data, smaller industry specific data collection and networking groups, press releases, analyst ratings and commentary, and public records such as SEC filings and bankruptcy proceedings.

Another feature of the subject matter of this application is the ability of the Program to identify Account overlaps between Members even if Members do not consistently name their Accounts. For example, one Member may refer to an Account as “Amalgamated,” (801) while another may call the same company “Amalgamated Solutions,” (802) and a third may call the same company “Amalgamated Soln Inc.” (803) The Program may identify those three as being the same Account by analyzing the data submitted by a Member, or may request clarification from a Member. This process of normalization (804) permits the Program to ensure that Member submitted data is properly ascribed to the correct Account before such data is analyzed and transformed by the Program (805). The Program would then report data on this exemplary Account to its Members using the Members own preferred nomenclature. In this manner, Members reporting data on Amalgamated, Amalgamated Solutions, or Amalgamated Soln Inc. would receive, in turn, data from their Trusted Peers referring to the Accounts by the names Amalgamated (806), Amalgamated Solutions (807), or Amalgamated Soln Inc. (808) respectively, even though all three terms refer to the same entity. In this manner, the Program adapts to each Member's naming convention to enhance the user experience. This unique capability is referred to as Client Data Preservation.

The subject matter of this application thereby allows Members to view real-time, or near real-time credit reports for their Accounts as calculated from the experiences of their Trusted Peers and the ability to compare such highly relevant and targeted information to a myriad of other sources of relevant data. The subject matter of this application thereby provides to Members a more detailed and complete picture of an Account's financial status than would otherwise be available. Such detailed and complete reports allow Members to make highly-informed decisions concerning their current and potential Debtors.

I claim:

1. A method for providing a customized credit rating for a business comprising:
a. a plurality of members electronically sharing data about their business customers with a computer program or computer program administrator;
b. each member receiving a list of other members that share common customers;
c. each member selecting from said list a subset of members from which to receive information;
d. electronically compiling, transforming, and rating, data received from said subset pertaining to a customer to create a personalized report for each member; and
e. electronically presenting a member with the personalized report.

2. The method of claim 1 further comprising the step of verifying the identity of each business customer to eliminate error due to members using variations of a customer's name, and maintaining a member's preferred nomenclature in reports presented to said member.

3. The method of claim 1 wherein the said electronically shared data is shared as it is updated, and wherein said personalized reports are generated and updated in real-time or near real-time following the receipt of new data from any member contributing data to the report.

4. The method of claim 1 further comprising the steps of
a. identifying networks of members based on the commonality of one or more factors such as business market niche, geographical regions served, annual revenues, or other such identifying factors;
b. presenting a member with a list of the said identified networks which comprise that member and a list of the other constituents of such networks.
